(19) United States
(12) Patent Application Publication
(10) Pub. No.: US 2011/0090954 A1
(43) Pub. Date: Apr. 21, 2011

(54) Video Codes with Directional Transforms

(76) Inventors: Robert A. Cohen, Somerville, MA (US); Sven Klomp, Hannover (DE); Huifang Sun, Billerica, MA (US); Anthony Vetro, Arlington, MA (US)

(21) Appl. No.: 12/603,177

(22) Filed: Oct. 21, 2009

(51) Int. Cl. H04N 7/24

(52) U.S. Cl. 375/240.03; 375/240.12; 375/E07.021; 375/E07.032; 375/E07.245

(57) ABSTRACT

An encoded video in the form of a bitstream includes a sequence of frames, and each frame is partitioned into encoded blocks. A context for decoding is selected for each encoded block. The bitstream is entropy decoded based on the context to obtain a transform indicator difference. The transform index, which indicates a transform type and a transform direction, is based on the transform indicator difference and a predicted transform indicator. Transform coefficients are obtained from the bitstream, and inverse transformed according to the transform index to produce a decoded video.

### RELATED APPLICATION

This Non-Provisional Application is related to US Non-Provisional Application No. 12/XXX,XXX, entitled “Directional Transforms for Video and Image Coding,” filed Oct. 21, 2009, by Cohen et al., co-filed herewith, and incorporated herein by reference.

### FIELD OF THE INVENTION

The invention relates generally video codecs, and more particularly to encoding and decoding blocks of pixels in video frames using directional transforms and information associated with adjacent previously decoded blocks.

### BACKGROUND OF THE INVENTION

### Codecs

A digital video codec compresses and decompresses a video. Codecs can be found in broadcast equipment, televisions, personal computers, video recorders and players, satellites, as well as mobile and on-line devices. Codecs partition each frame of the video into blocks of pixels, and process the block one at the time.

During encoding, spatial and temporal redundancies are eliminated to reduce the data rate. The invention is particularly concerned with the transforms that are used during encoding and decoding videos. The most common transform is a discrete cosine transform (DCT) in the MPEG and H.264/AVC standards. The DCT converts pixel intensities in the spatial domain to transform coefficients in the frequency domain. The coefficients are then quantized, and entropy encoded to produce a compressed bitstream. The bitstream can be stored on a medium (DVD), or communicated directly to the decoder. During decoding, the steps are inverted. After entropy decoding and inverse quantization, an inverse transformation is applied to recover the original video.

Generally, the number of decoders, e.g., consumer products all over the world, far exceeds the number of encoders. Therefore, to enable interoperability, only the bitstream and the decoding process need to be standardized. The encoding process is typically not specified at all in a standard.

Transforms

The DCT includes a horizontal 1-D DCT applied to each row of pixels in the block and a vertical 1-D DCT applied to each column. For blocks with predominantly horizontal or vertical features, the 2-D DCT is efficient. However, the 2-D DCT does not efficiently transform blocks that contain features that are not horizontal or vertical, i.e., directional features, where directional refers to orientations other than horizontal and vertical.

Generally, there are two methods that implement directional transforms. The first method applies the 2-D DCTs along predefined paths within the block. The second method applies a directional filter, followed by the 2D DCT. Typically, a fan filter partitions the block into a set of directional sub-bands. Transforms are subsequently applied to each sub-band. Directional transforms such as contourlets are implemented in this way. Contourlets efficiently transform frames containing smooth regions separated by curved boundaries.

Directional transforms have been used to supplement the existing 2-D DCT or DCT-like transform for existing video coding methods, such as H.264/AVC. During the encoding process, the H.264/AVC encoder selects from a set of transforms, such as the conventional 2-D transform, and a set of directional transforms. The transform that yields the best performance, in a rate/distortion sense, is then selected for the encoding and decoding.

After the transform, improvements can by made in the entropy encoding of the corresponding data by leveraging statistics of the directional data. In the H.264/AVC, a context adaptive binary arithmetic coder (CABAC) or a context adaptive variable length coder (CAVLC) is used to entropy encode different types of data. The input symbols are mapped to binary code words and compressed by an arithmetic coder. Contexts are used to adapt the statistics used by the arithmetic coder. Each context stores the most probable symbol (either 0 or 1), and the corresponding probability.

The H.264/AVC standard is designed to use the 2-D DCT. Existing methods can use directional transforms to extend the performance of H.264/AVC encoders. However, those methods still generate and code the direction-related decisions and data using the conventional H.264/AVC framework. Thus, there is a need to efficiently represent directional information, as well as a need for improving coding efficiencies.

### SUMMARY OF THE INVENTION

### Brief Description of the Drawings

FIG. 1A is a block diagram of a video system according to embodiments of the invention;

FIG. 1B is a block diagram of a decoder according to embodiments of the invention;

FIG. 1C is a block diagram of an encoder according to embodiments of the invention;

FIG. 2 is a block diagram of a sub-block and partition directional processing module according to embodiments of the invention;

FIG. 3 is a block diagram of a transform type and direction decision module according to embodiments of the invention;

FIG. 4 is a block diagram of the direction inference module according to embodiments of the invention;

FIG. 5 is a block diagram of a directional prediction module according to embodiments of the invention;

FIG. 6 is a block diagram of a directional index encoding module according to embodiments of the invention;

FIG. 7 is a schematic of a first embodiment of the directional index encoder module according to embodiments of the invention; and

FIG. 8 is a schematic of a second embodiment of the directional index encoder module according to embodiments of the invention; and

FIGS. 9-10 are flow diagrams for a context generation module according to embodiments of the invention.

### DETAILED DESCRIPTION OF THE PREFERRED EMBODIMENTS

### Codec

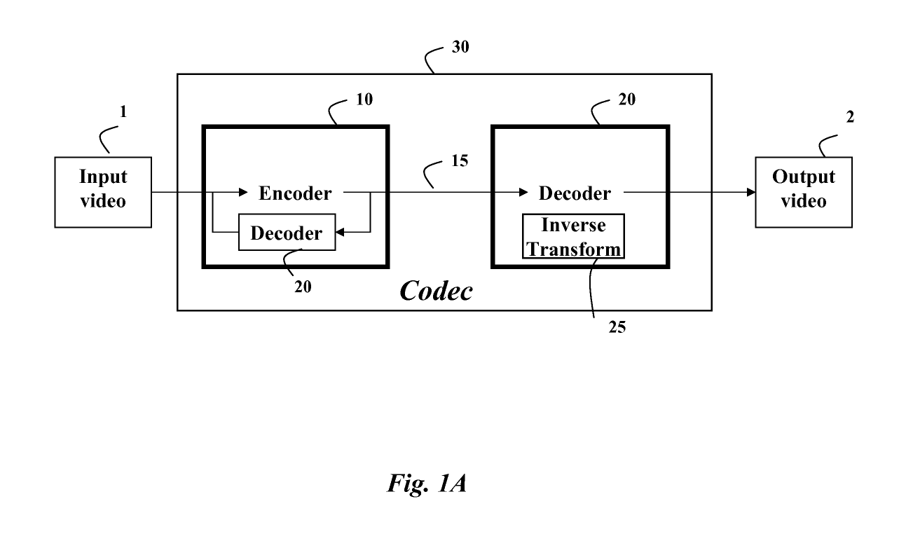

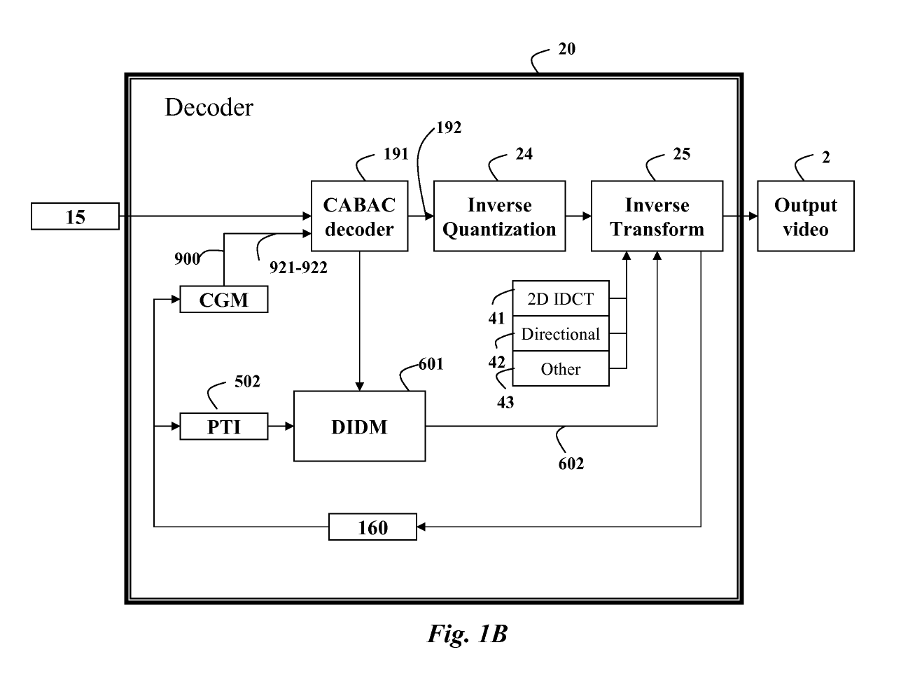

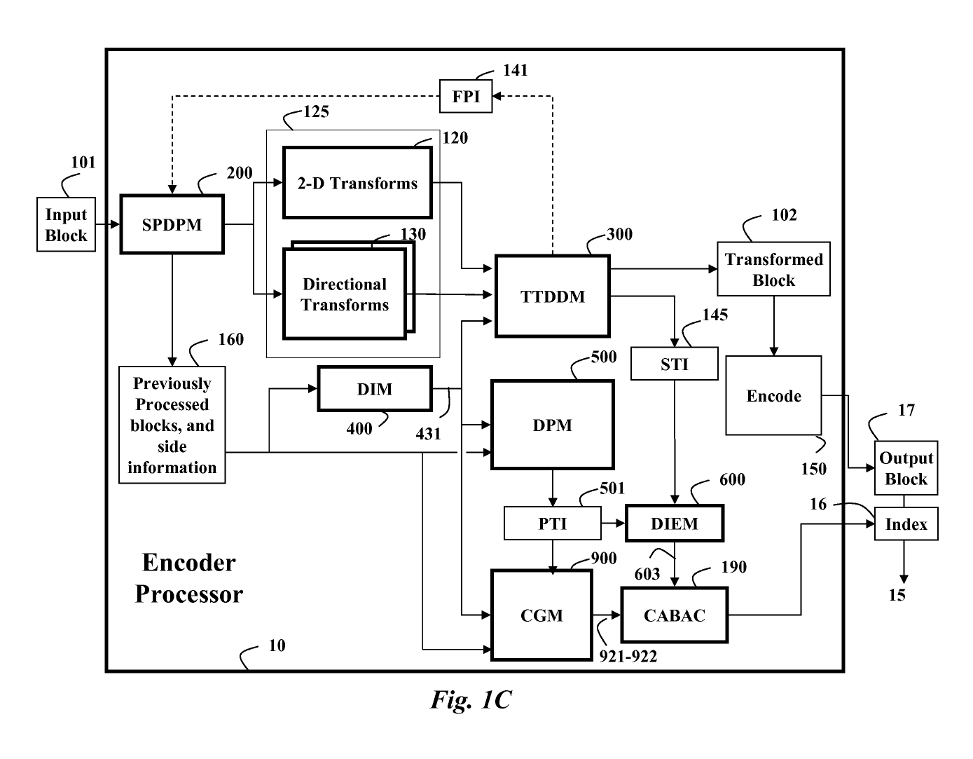

FIG. 1A shows a video system according to embodiments of our invention. The system includes an encoder 10 and a decoder 20, in combination a codec 30. The codec can be implemented in processors including memories and input/output interfaces as known in the art.

The encoder compresses an input video 1 into a bitstream 15. The encoder applies transformation, quantization, and entropy encoding to the input video as described in detail below. To ensure that the output video accurately reflects the input video, the decoder 20 performs the inverse steps in an inverse order. In addition, the encoder typically includes the equivalent of the decoder to provide feedback for the encoding process. Because all encoder variables are readily available in the encoder, the decoder in the encoder is relatively simple. The invention is particularly concerned with the inverse transform 25.

To ensure interoperability between the encoder and the decoder, video coding standards typically only specify the bitstream and the decoding process. However, it is understood that a description of the encoding process, as detailed below, is sufficient to exactly deduce the inverse decoding process by one of ordinary skill in the art.

Decoder

FIG. 1B show relevant portions of our decoder 20. The decoder receives the encode bit stream 15, and information 160. The bit stream is presented to a CABAC entropy decoder 191, which produces quantized transform coefficients 192 according to the information. For the first block, the information can be an initial context. Subsequently, the information relates to previously processed (decoded) blocks.

The coefficients are inverse quantized 24 and inverse transformed 25 so that the decoded blocks form the output or decoded video 2. The transform can be an inverse discrete cosine transform. The transforms can include a 2D inverse discrete cosine transform, and a set of inverse directional transforms.

The information 160 is presented to the context generation module (CGM) of the decoder, which forwards selected contexts 921-922 to the CABAC decoder. Predicted transform indicators (PTI) 501 of the previously decoded blocks 160 are presented to a directional index decoding module (DIDM) 601, which generates a transform indicator 602 for the inverse transform 25. The inverse transform can use any of the inverse transforms, e.g., 1D horizontal and 1D vertical inverse DCTs (2D IDCT) 41, a set of inverse directional transforms 42, and any other known inverse transforms 43.

It is noted that current video coding standards only use a single pre-specified transform so that an index to different transforms is not needed. Also, current standards do not consider side information related to previously decoded blocks during the inverse transform.

Encoder

FIG. 1C shows the relevant details of the encoder 10. The encoder uses directional transforms according to embodiments of the invention. The steps of the method as shown can be performed in a processor of an encoder. The processor includes memory and input/output interfaces as known in the art.

Input to the encoder is a block 101 of a frame of a video to be coded. As defined herein, blocks include macroblocks, sub-blocks, and block partitions, generally an array of pixels. In most coding applications, the operations are preferably performed on macroblocks and sub-blocks The block can contain original video data, residuals from a spatial or motion-compensated prediction of video data, or other texture-related data to be transformed. The block can be partitioned into sub-blocks by a sub-block partition directional processing module (SPDPM) 200. Herein, the sub-blocks are processed one at a time as “blocks.”

Each block is transformed using transforms selected from a conventional two-dimensional discrete cosine transform (2-D DCT) 120, a set of directional transforms 130, or other transforms, generally transforms 125. The output of the transform is measured by a transform type and direction decision module (TTDDM) 300. The TTDDM uses a metric, such as a rate/distortion cost, to determine which of the transforms provides the best performance. The rate/distortion cost is a sum of a encoding rate and a scalar multiplied by the distortion. The transform type and direction have a minimal cost are selected for the transforming. The performance can be, but is not limited to, a measure of the coding efficiency. The idea is that the transform which has the best performance is selected for the encoding, and the selected transform is signaled to the decoder as in an index 16 in the bitstream.

The TTDDM can also receive input from a direction inference module (DIM) 400. The input to the DIM is a collection of data 160 indicating the transforms and directions used for adjacent previously processed blocks. The output of the DIM is a value or set of values corresponding to the data 160, such as preferred directions 431. The TTDDM uses this information to make the decision as to which transforms and directions are used to encode the block 101. The TTDDM can also forward a final partitioning indicator (FPI) 141 to the SPDPM as a guide for the partitioning. The TTDDM module produces the transformed block 102 and a selected transform indicator (STI) 145 representing the selected transform and direction.

Then, the transformed block 102 can be appropriately encoded 150 using entropy coding to produce an encoded output block 17.

The direction prediction module (DPM) 500 also receives information from the DIM, and information related to the previously processed blocks 160. The DPM uses this information to generate a predicted transform indicator (PTI) 501. The PTI is input to a directional index encoding module (DIEM) 600, along with the STI 145. The DIEM converts the representation to a binary codeword 603 for encoding by a context-adaptive binary arithmetic coder (CABAC) 190.

The contexts used by the CABAC are determined by a context generation module (CGM) 900. The input to the CGM is information about the transforms and directions used by adjacent previously encoded blocks from the DIM, or already coded information from the current block. The CGM produces contexts for the CABAC to encode the binary directional index. The CABAC outputs an encoded transform index 16.

Sub-Block and Partition Directional Processing Module

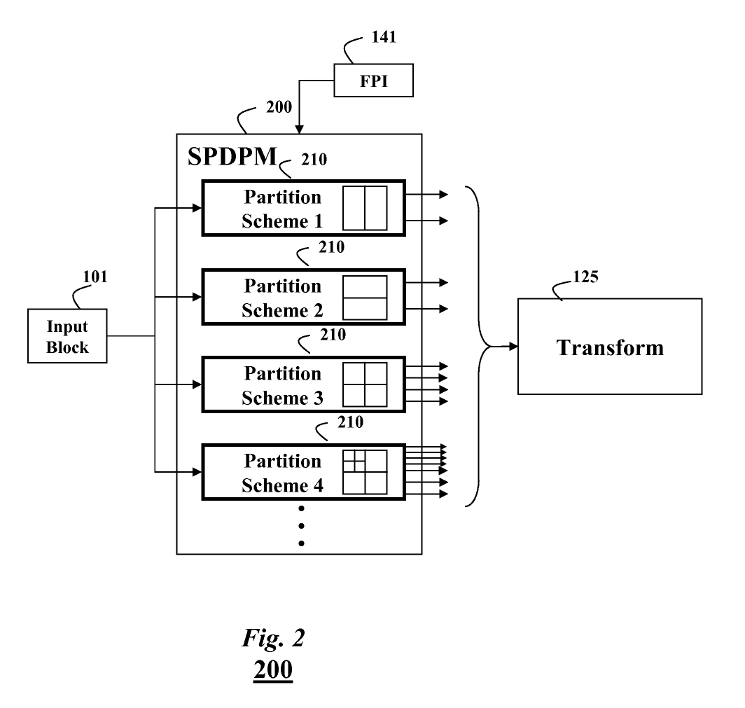

FIG. 2 shows details of the SPDPM 200. The pixels in the input block 101 can represent video-related information, such as video frame data, motion-compensated prediction residuals, and spatial prediction residuals. The SPDPM partitions the block into partitions 210, generally arrays of pixels. The conventional or directional transforms 125 are applied to the partitions. The final partitioning indicator 141 produced by the TTDDM indicates which partitions to use for the best performance.

Transform Type and Direction Decision Module

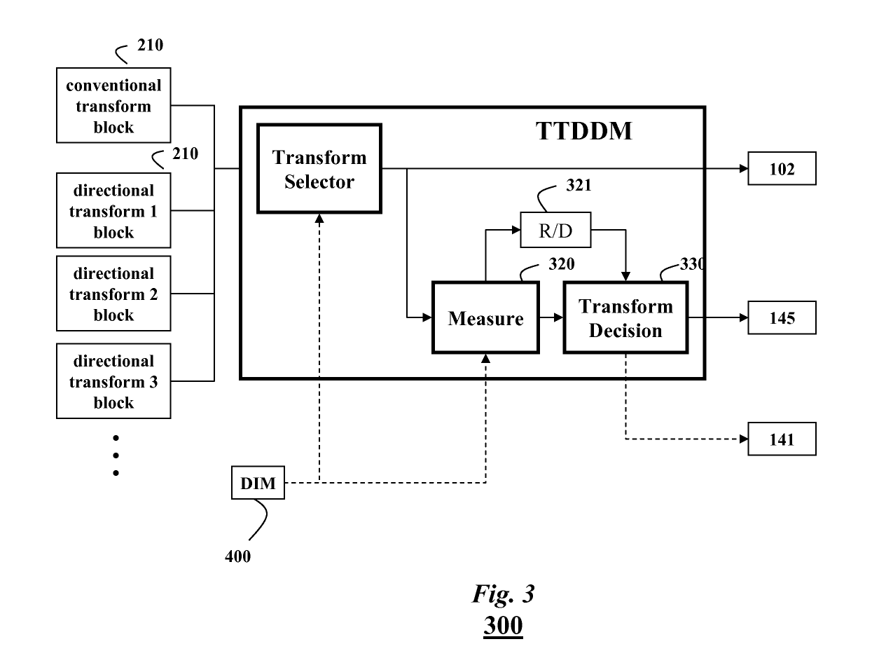

FIG. 3 shows the TTDDM 300 for selecting the best transform and direction to use to transform the block 210. A transform selector 310 chooses which among available transform types are to be sent to measuring module 320, which determines a metric 321, such as the rate/distortion (R/D) cost, that is used to select transform.

The transform selector can be influenced by the DIM 400. The DIM, for example, can examine adjacent blocks to determine which directions are more likely to perform well for the current block. The measuring can then be limited to a subset of available directions, thus reducing the processing time. After these measurements are used to determine the best direction or transform, the selected transform indicator 145, and the corresponding transformed block 102 are output. If the TTDDM is operating on a selection of partitions, then the final partitioning indicator 141 that yields the best performance is also output to the SPDPM.

Direction Inference Module

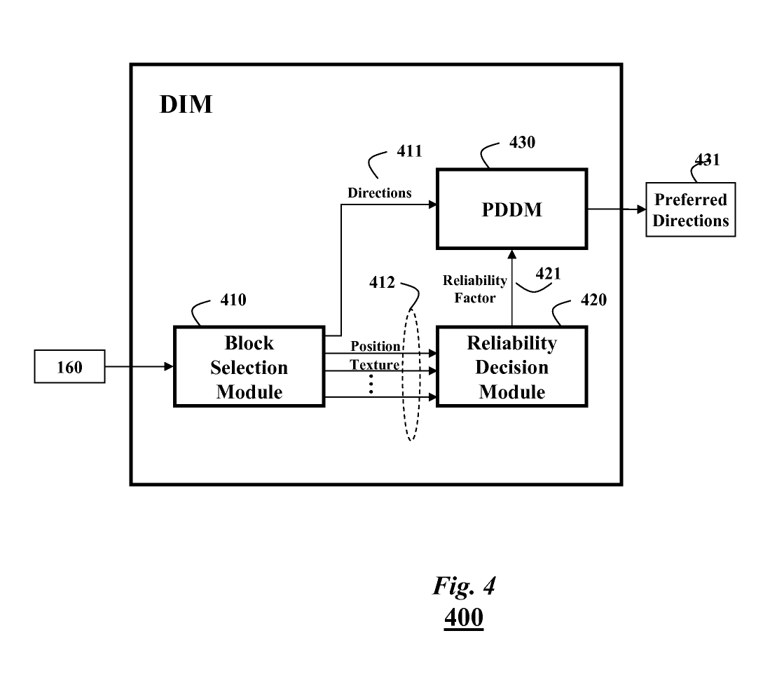

FIG. 4 shows the DIM 400. The block selection module uses the previously processed blocks and side information 160 to determine possible transform directions 411 for the current block. The possible transform directions are used to determine a set of preferred directions 431. This subsequently is used by the DPM to reduce the number of bits needed to represent this information, which results in an improved efficiency in the encoder and the decoder.

A block selection module (BSM) 410 selects from the blocks 160 based on criteria, such as a distance of the selected blocks to the current block. The reliability decision module (RDM) 420 estimates the reliability of the selected blocks. The RDM module can use texture information, the position and other block data 412. A reliability factor 421 of each of the selected blocks, and the corresponding transform direction 411 are fed into the preferential direction determination module (PDDM) where the preferred directions 431 are identified.

Directional Prediction Module

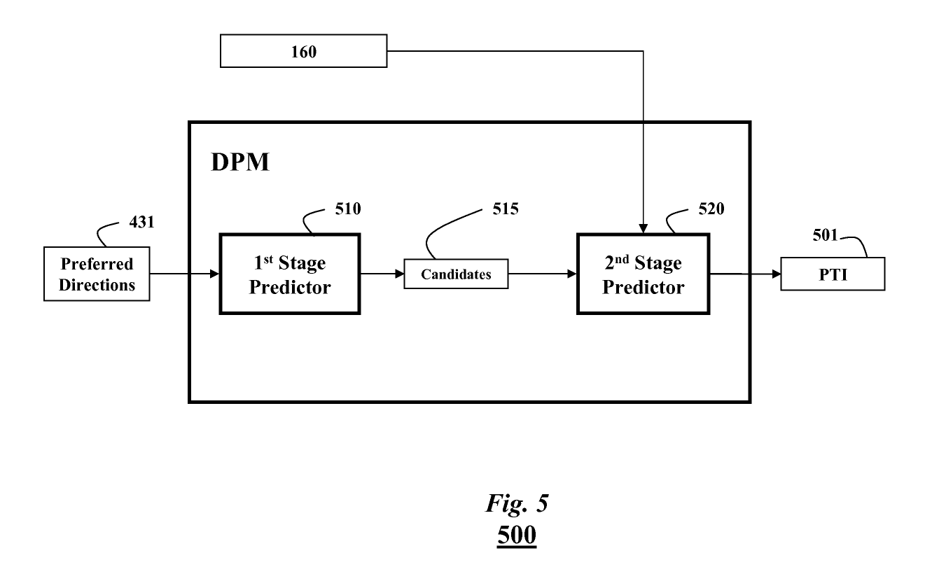

FIG. 5 shows the DPM 500 to determine the predicted transform indicator 501 for the DIEM 600 and CGM. A first stage predictor 510 selects candidates 515 from the preferred directions 431. A second stage predictor 420 uses these candidates and the encoded side information 160 to select the preferred transform indicator 501.

For encoding transformed texture residuals, the selected transform direction indicator 145 can be correlated with a texture predictor, such as an intra-prediction mode used in H.264/AVC. Therefore, the side information fed to the DPM can include, for example, the intra-prediction mode to select the indicator 501.

Directional Index Encoding Module

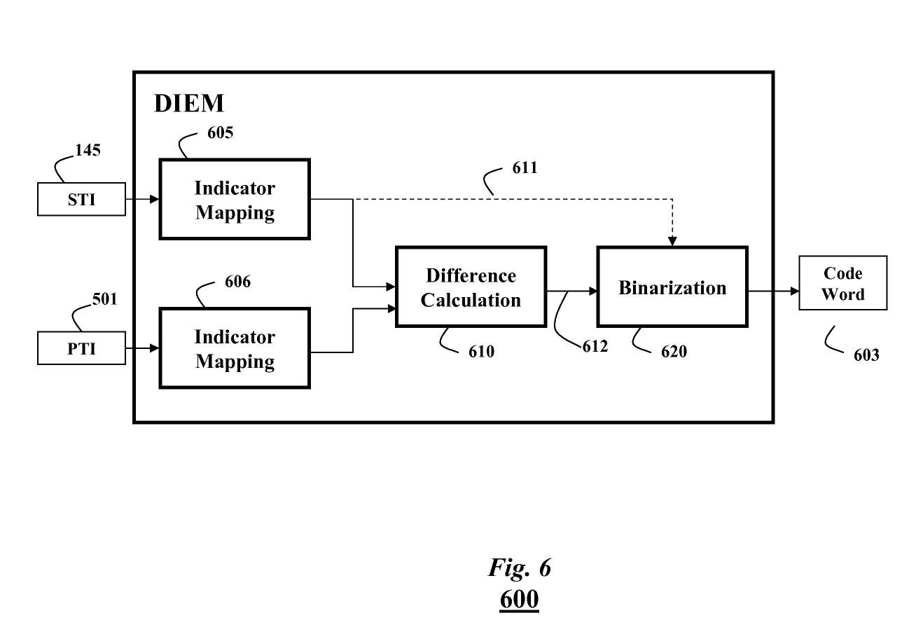

FIG. 6 shows the DIEM 600. Input includes the selected transform indicator 145 and the predicted transform indicator 501, which are mapped 605-606 to a meaningful representation of the directions. Different mappings 605-606 can be used for the selected and the predicted transform indicators. A difference between the two directions is determined 610 as a transform indicator difference 612. Because the prediction is a reasonable approximation of the selected transform direction, small angle differences should result in similar code words that can be effectively encoded. The difference is binarized 620 to the code word 603, which is entropy coded by the CABAC 190 as the encoded transform index 16. It is understood that any context adaptive entropy coder can be used, as well as variable length coding (VLC). The difference calculation can be bypassed 611 as described below.

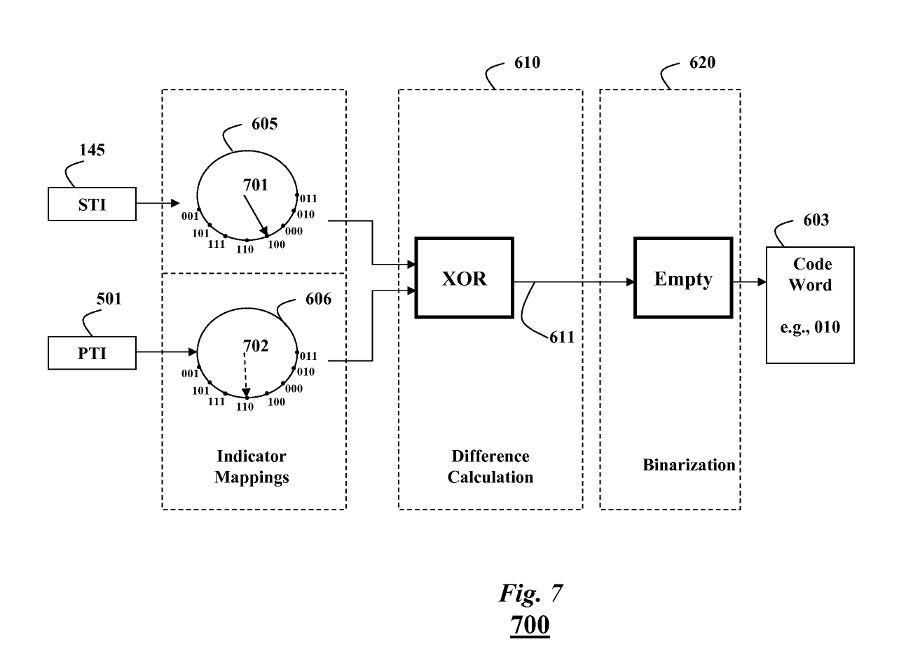

FIG. 7 schematically shows a first embodiment of the DIEM 600. For example, there are eight possible transform directions 701 and corresponding predictions 702. The transform direction is selected by the selected transform indicator 145, and the prediction is selected by the PTI 501. The transform indicators are mapped to a Gray code, in which adjacent directions differ only by one bit. The code words for the selected and the predicted directions are compared bit by bit with an exclusive-OR (XOR) 610 operation to obtain the difference 611. For a precise predictor, this yields in a bit stream with mostly zeros for a low entropy. Because the indicator mappings 605-606 use binary representations, the binarization 620 is not used.

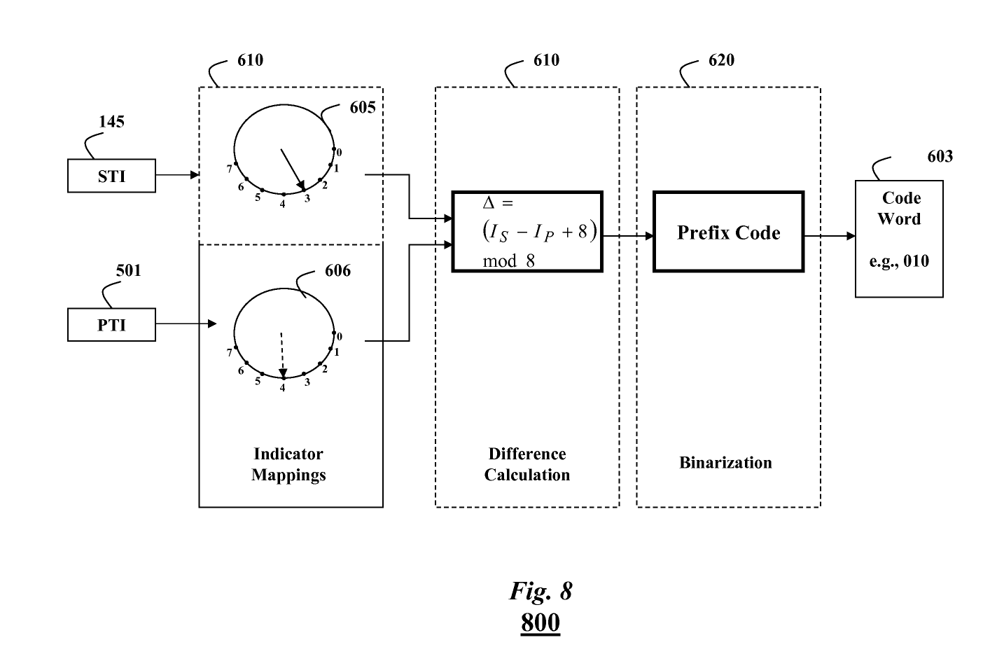

FIG. 8 shows a second embodiment of the DIEM. In this embodiment, the directions are represented by a uniformly continuous sequence of numbers. The difference 610 is

Δ=(I_{S}−I_{P}+N)mod N,

where I_{S} and I^{P} are the mapped indices of the selected and predicted direction indicators, respectively, and N is the number of possible direction, e.g., eight. Because small differences are more probable, the binarization 620 codes differences close to zero (0, 1, N−1, 2, N−2, . . . ) with fewer bits. The difference calculation can be bypassed 611 and the mapped transform indicator is forwarded directly to the binarization module 620. In this case, the context generation module 900 uses the predicted transform indicator to select an appropriate context.

Context Generation Module

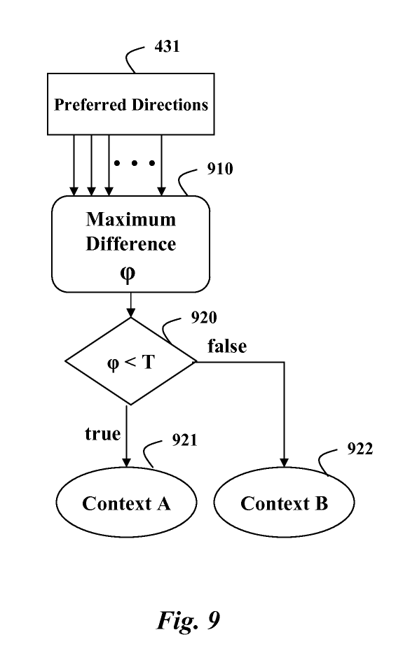

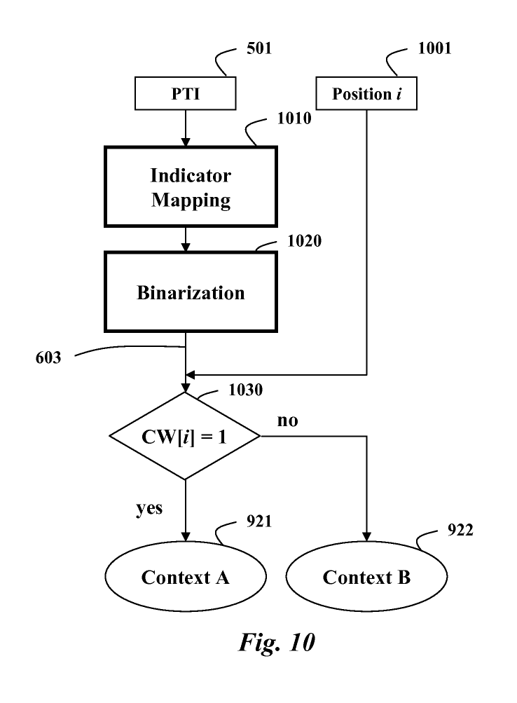

FIGS. 9-10 show embodiments of the CGM 900. The CGM selects contexts 921-922 for the CABAC 190. More than two contexts can also be selected. To determine the contexts, the CGM can use the preferred processed block information 160, the PTI 501, and the preferred directions 431. The contexts A and B distinguish accurate predicted directions and inaccurate predictions. FIG. 9 shows how the preferred directions 431 are used to determine the contexts. A maximum difference φ is determined 910 and compared 920 to a predetermined threshold T. If the difference is less than the threshold, then the prediction is accurate in context A 921, otherwise the context B 922 is inaccurate. For example, if the DIEM is used, then the bits fed to CABAC are mostly zeros, and context A is selected to fit this probability. The context selection of the CGM 900 can also consider other factors, such as bit position, to decide among more than two contexts.

The embodiment shown in FIG. 10 assumes that the DIEM bypasses 611 the difference calculation 610. The predicted transform indicator 501 and a positional index i 1001 representing which bit from the index 603 is to be encoded are inputs. The PTI 501 is mapped 1010 to a binary code word with the same indicator mapping 605 used in the DIEM. Because both code words should be the same, the most probable bit of the CABAC should be the same as the current bit CW[i] of 1030. Thus, if the comparison 1030 indicates the current bit is 1, the context A 921, which prefers 1, is selected, otherwise the context B 922, where 0 is the preferred bit, is selected.

Although the invention has been described by way of examples of preferred embodiments, it is to be understood that various other adaptations and modifications can be made within the spirit and scope of the invention. Therefore, it is the object of the appended claims to cover all such variations and modifications as come within the true spirit and scope of the invention.

We claim:

1. A method for decoding a bitstream, wherein the bitstream corresponds to an encoded video, wherein the encoded video includes a sequence of frames, wherein each frame is partitioned into encoded blocks, for each encoded block comprising the steps of:
selecting a context for decoding the encoded block;
entropy decoding the bitstream based on the context to obtain a transform indicator difference;
determining a transform index that indicates a transform type and a transform direction based on the transform indicator difference and a predicted transform indicator;
obtaining transform coefficients from the bitstream; and
transforming inversely the transform coefficients according to the transform index to produce a decoded block of a decoded video, wherein the selecting, determining, obtaining and transforming steps are performed in a decoder.

2. The method of claim 1, wherein an initial context is selected for a first encoded block, and the contexts for subsequent encoded blocks are based on previously decoded blocks.

3. The method of claim 1, wherein the transform type includes a 2D inverse discrete cosine transform, and a set of inverse directional transforms.

4. The method of claim 3, wherein the inverse directional transforms are one dimensional.

5. The method of claim 1, wherein the entropy decoding uses a context adaptive arithmetic decoder.

6. The method of claim 1, wherein the transform direction indicates one of eight transform directions.

7. The method of claim 1 wherein the transform direction indicates one of any number of transform directions.

8. The method of claim 1, wherein the transform indices of adjacent transform directions differ by one bit.

9. The method of claim 1, wherein the determining further comprises:
applying an exclusive OR to the transform indicator difference and the transform indicator.

10. The method of claim 1, further comprising:
representing the transform directions by a uniformly continuous sequence of numbers.

11. The method of claim 1, wherein the blocks include macroblocks, sub-blocks, block partitions, or an array of pixels.

12. The method of claim 1, further comprising:
quantizing inversely the transform coefficients according to a quantization parameter.

13. The method of claim 1, further comprising:
determining the transform type and the transform direction according to a metric.

14. The method of claim 13, wherein the metric is a rate/distortion cost.

15. The method of claim 14, wherein the rate/distortion cost is a sum of an encoding rate and a scalar multiplied by the distortion, and the transform type and direction having a minimal cost is selected for the transforming.

16. An apparatus for decoding a bitstream, wherein the bitstream corresponds to an encoded video, wherein the encoded video includes a sequence of frames, wherein each frame is partitioned into encoded blocks, comprising:
means for selecting a context for decoding each encoded block;
an entropy decoder configured to decode the bitstream based on the context to obtain a transform indicator difference;
means for determining a transform index that indicates a transform type and a transform direction based on the transform indicator difference and a predicted transform indicator; and
means for obtaining transform coefficients from the bitstream; and
means for transforming inversely the transform coefficients according to the transform index to produce a decoded video.
